(19) United States
(12) Patent Application Publication
(10) Pub. No.: US 2013/0289152 A1
(43) Pub. Date: Oct. 31, 2013

(54) METHOD FOR PRODUCING FOAMED MOLDINGS

(71) Applicants: Hans-Guido Wirtz, Leverkusen (DE); Frank Grimberg, Dormagen (DE); Reinhard Albers, Leverkusen (DE); Andreas Pielasch, Bergisch Gladbach (DE)

(72) Inventors: Hans-Guido Wirtz, Leverkusen (DE); Frank Grimberg, Dormagen (DE); Reinhard Albers, Leverkusen (DE); Andreas Pielasch, Bergisch Gladbach (DE)

(73) Assignee: BAYER INTELLECTUAL PROPERTY GMBH, MONHEIM AM RHEIN (DE)

(21) Appl. No.: 13/879,934

(22) PCT Filed: Oct. 28, 2011
(86) PCT No.: PCT/EP11/69052

§ 371 Date: Jul. 1, 2013

(30) Foreign Application Priority Data
Nov. 3, 2010 (DE) 102010043329.2

(51) Int. Cl. C08J 9/04

(52) U.S. Cl. CPC C08J 9/04
USPC 521/170

(57) ABSTRACT

A method for producing foamed mouldings comprises the steps of providing a mould (1) and introducing a foam-forming reaction mixture (6) into the mould (1), wherein the foam-forming reaction mixture (1) is introduced into the mould (1) under constant injection pressure and in a quantity which is variable over time. The introduced quantity of the foam-forming reaction mixture is changed over time by varying the output of a pump motor acting on the reaction mixture.

The present invention relates to a method for producing foamed mouldings, comprising the steps of preparing a mould and of introducing a foam-forming reaction mixture into the mould.

At present, cavities to be insulated with polyurethane foams are insulated either continuously, as is the case for metal panels or insulation panels, or discontinuously, for example in cooling appliances, pipes or discontinuous panels. In these methods, constant discharge quantities of the insulation material are used which have to lie within certain limits, according to the particular application, in order to meet the requirements for the polyurethane foam structures, reactivity profiles and the mixing requirements.

An example of a conventional method for producing insulations for cooling appliances is filling in a flat position, in which the appliance lies on its back and is filled either from the compressor stage or the top area. Another example of a further developed conventional method is the “top flow” method, in which the reaction mixture is introduced into a mould from below and can thus spread out on the base of the mould.

With a constant amount of material injected per unit of time, the mixture that reacts to form the polyurethane foam is applied in a comparatively limited area. However, particularly with complex geometries of the cavity to be foam-filled, this has the disadvantage of a less favourable predistribution of the reaction mixture.

DE 10 2008 040 598 A1 discloses a method of foam filling a hollow body, in particular a domestic cooling appliance housing, with the steps of placing an injection nozzle at an inlet opening of the hollow body, injecting a foam former into the hollow body with the aid of the injection nozzle and allowing the injected foam former to expand. Here, the distance travelled by the foam former from the injection nozzle to a point of impact on an internal wall of the hollow body during the injection operation is reduced.

One way of varying the distance travelled by the foam former is to shift the injection nozzle's direction of moulding during the injection operation. According to DE 10 2008 040 598 A1, however, it is preferred to reduce the distance travelled by the foam former by reducing its delivery rate at the injection nozzle and thus the jet energy for the foam material. This is said to be achievable by means of a nozzle having a variable aperture cross section.

However, one disadvantage of this method is that a special nozzle is required. This results in change-over costs and periods of downtime in existing plants.

The present invention has therefore set itself the object of providing a method for producing foamed mouldings in which the above disadvantages of the prior art are overcome. In particular, it has set itself the object of providing such a method in which a more homogeneous foam density distribution occurs in hollow bodies to be foam-filled and which can be carried out with injection nozzles that do not have to be variable in terms of their aperture cross section.

The object is achieved according to the invention by a method for producing foamed mouldings, comprising the following steps:
A) providing a mould and
B) introducing a foam-forming reaction mixture into the mould,
   which is distinguished by the fact that in step B) the foam-forming reaction mixture is introduced into the mould under constant injection pressure and in a quantity which is variable over time, wherein the introduced quantity of the foam-forming reaction mixture is changed over time by varying the output of a pump motor acting on the reaction mixture.

The method according to the invention is suitable in particular for hollow bodies, the geometry of which places particular demands on the flow properties of the reaction systems. These include in particular stretched geometries, geometries with high slenderness ratios, with thin and narrow hollow body chambers and long distances from the injection point of the reaction mixture to the end of the flow path of the hollow body to be filled.

The mould provided in step (A) of the method according to the invention can comprise a closed or an open mould. “Open” here means that at least two side walls are present. The foam obtained can be removed from the mould or can remain in the mould for its final destination. Particularly suitable according to the invention is a mould with which integral insulations of cooling appliances are produced. The mould is preferably arranged such that reaction mixture introduced therein can spread out on the base thereof.

The foam-forming reaction mixture can be produced in step (B) using a conventional high-pressure mixer which, in the case of modification, is modified with a constant pressure injector and optionally a dynamic throttle, and introduced into the mould by means of a discharge tube. One discharge tube or multiple discharge tubes per mould can be used. After completion of foaming, the reaction mixture cures.

Furthermore in the method according to the invention, the foam-forming reaction mixture is introduced into the mould under constant injection pressure. The term “constant” here includes technically unavoidable fluctuations. In particular, fluctuations of ±15% around an average are included. It is an advantage of a constant injection pressure that, particularly with exothermic reactions, good mixing of the reaction mixture can take place. The input of energy into the reaction system which is also constant owing to the constant pressure has a favourable effect on the reaction kinetics and thus also the quality of mixing.

Preferably, the foam-forming reaction mixture is obtained from mixing multiple components in a mixing head and is introduced into the mould immediately afterwards. The outlet aperture of the mixing head here can simultaneously represent the discharge tube, with which the mixture is introduced into the mould.

In the event that the foam-forming reaction mixture is obtained from the mixing of multiple components in a mixing head and the mixing head comprises one or more injection nozzles, the pressure that is kept constant in the method according to the invention is the pressure applied at the injection nozzles.

The mixing of liquid reaction components takes place in a mixing head in polyurethane processing, a distinction being made between high-pressure and low-pressure mixing. In the high-pressure mixing process, which is preferably used for the method being described, the pressure energy of the reaction components produced by means of pumps is converted to kinetic energy by nozzles. By injecting the components into a comparatively small mixing chamber located in the mixing head, the kinetic energy is spatially concentrated and utilised to mix the reaction components. Conventional injection pressures are between 120 and 170 bar, resulting in flow rates of approx 140 to 180 m/s being achieved, depending on the material density.

The change in pressure associated with varying the discharge quantity per unit of time can be countered by means of constant pressure injectors. Examples of suitable nozzles are spring-loaded constant pressure injectors, or pneumatically (gas spring) or hydraulically controlled constant pressure injectors.

The fact that the foam-forming reaction mixture is introduced into the mould in a quantity which is variable over time means that the material flow of the reaction mixture into the mould, which can be expressed for example in grams per second, is variable. The variation over time can be linear or can follow other time rules.

The introduction of the reaction mixture into the mould is controlled by the output of a pump motor acting on the reaction mixture. This naturally includes the case in which, where there are multiple components of the foam-forming reaction mixture to be conveyed, multiple motors are influenced. The input profile can be adjusted for each mould individually.

For an introduction of the reaction mixture into the mould which is constant over time, figuratively speaking an oval-shaped distribution of a reaction mixture injected horizontally on to the base of a mould is obtained. On the other hand, with the varying over time of the discharge performance according to the invention, the reaction mixture is obtained in the form of an elongated strip.

The expanded reaction mixture with a better predistribution thus has shorter paths in order to fill the mould. Shortening of the flow paths leads to material savings and foam structures that are more isotropic or more homogeneous. In other words, a more uniform bulk density distribution can be obtained in the finished foam. The strength properties of the foam are also improved, since shear losses are minimised. Foam systems can be used which are suitable for the shortest possible flow paths. These are also referred to as “high-speed systems”.

In the method according to the invention, mixing heads or injection nozzles of which the aperture cross section is not variable in relation to discharge of the mixture can be used to introduce the reaction mixture into the mould.

Preferably the foam-forming reaction mixture comprises a polyol component and a polyisocyanate component, so that a polyurethane foam is obtained. The foam can be open cell or closed cell. It is also favourable if the reaction mixture has a low initial viscosity, for example of ≧300 mPas to ≦2000 mPas at the temperature prevailing during mixing.

Preferred embodiments of the method according to the invention are described below, it being possible to combine the embodiments with one another at will, provided that the contrary cannot clearly be inferred from the context.

In one embodiment of the method according to the invention, the output of the pump motor is varied by varying the speed of the motor using a frequency inverter. This can easily be achieved by means of a programmable logic controller (PLC) of the motor or motors.

In another embodiment of the method according to the invention, the foam-forming reaction mixture is obtained from the reaction of a first and a second reaction component and the first and second reaction component are each introduced into a mixing chamber by means of constant pressure injectors. Examples of suitable nozzles are spring-loaded constant pressure injectors, or pneumatically (gas spring) or hydraulically controlled constant pressure injectors. From the mixing chamber, the reaction mixture can then be introduced into the mould. The advantage of this method lies in a constant mixing quality of the two components. As already stated above, the two components are in particular a polyol system and a polyisocyanate.

In another embodiment of the method according to the invention, the foam-forming reaction mixture is selected such that a rigid polyurethane foam is obtained. Included in the term “rigid polyurethane foam” are polyurethane/polyisocyanurate rigid foams. For the production of rigid foams comprising urethane and/or isocyanurate groups, the following in particular can be used as starting components:
a) aliphatic, cycloaliphatic, araliphatic, aromatic and heterocyclic polyisocyanates, preferably diphenylmethane diisocyanate (MDI) or polyphenyl polymethylene polyisocyanates (polymeric MDI), polyisocyanates having carbodiimide groups, urethane groups, allophanate groups, isocyanurate groups, urea groups or biuret groups, particularly preferably based on polyphenyl polymethylene polyisocyanate, and
b) compounds having at least two isocyanate-reactive hydrogen atoms with a molecular weight in the range of 400 g/mol to 10000 g/mol, e.g. compounds having amino groups, thiol groups, hydroxyl groups or carboxyl groups. Preferred here are polyethylene glycols started on amino groups with primary hydroxyl groups.

The foams can be produced using conventional auxiliary substances and additives, such as catalysts, blowing agents, crosslinking agents, flame retardants, foam stabilisers, flow promoters and/or inhibitors.

The foam-forming reaction mixture preferably has a setting time of ≧15 s to ≦50 s. It can also be ≧20 s to ≦40 s. The setting time is generally the time after which, for example during polyaddition between polyol and polyisocyanate, a theoretically infinitely long polymer has formed. The setting time can be determined experimentally by dipping a thin wooden stick into the foaming reaction mixture at short intervals. The period from mixing the components to the time when threads remain hanging on the stick when it is withdrawn is the setting time. The setting times mentioned have the advantage that, in conjunction with the method according to the invention, moulds can be filled rapidly and completely.

In another embodiment of the method according to the invention, the time period during which the foam-forming reaction mixture is introduced into the mould in a quantity which is variable over time is ≧1 s to ≦20 s. This time period can also be ≧5 s to ≦10 s.

In another embodiment of the method according to the invention, in step B) the delivery rate of the introduced foam-forming reaction mixture is ≧0.5 m/s to ≦6 m/s. This value is preferably in a range of ≧1 m/s to ≦5 m/s.

If the reaction mixture is discharged from a mixing head which can be cleaned by an outlet cleaning piston or ram, it is useful if the delivery rate from the mixing head is measured at the ram.

In another embodiment of the method according to the invention, the delivery rate of the introduced foam-forming reaction mixture decreases over time in step B). This method is recommended for long, slender geometries of the mould, as encountered for example in housings for insulating elements of refrigerators. A decreasing input is also appropriate if the volume to be filled is uniformly distributed over the entire base area of the mould.

In another embodiment of the method according to the invention, the delivery rate of the introduced foam-forming reaction mixture increases over time in step B). This is advantageous in short, compact geometries of the mould.

In another embodiment of the method according to the invention, before and/or after step B) the foam-forming reaction mixture is introduced into the mould at a constant delivery rate over time. In this way, a ramped quantitative distribution can be achieved in the mould. This is advantageous in high-volume areas at the beginning and end of the mould.

In another embodiment of the method according to the invention, the foam-forming reaction mixture is introduced into the mould in a horizontal direction in step B). Preferably, the reaction mixture is introduced about 2 mm to 50 mm above the base of the mould. With horizontal application, the reaction mixture can be distributed particularly uniformly.

In another embodiment of the method according to the invention, the mould seen in cross section has a horizontally arranged base volume and vertically arranged volumes communicating with the base volume. In this way, integral insulating elements for refrigerators can be produced. When filling the mould with the reaction mixture, this is firstly distributed in the base volume and then, during foaming, rises up in the vertical volumes. These volumes or channels can also have dimensions extending over the entire length or width of the mould. Examples of thicknesses are between 20 mm and 200 mm, and in addition, inserted lines, channels, panels and tubes are possible, which can vary the cross section thicknesses.

In another embodiment of the method according to the invention, the mould comprises an external duct and an internal duct arranged therein, and the foam-forming reaction mixture is introduced between the internal and external ducts. As a result, insulated ducts can be obtained. In this case, the internal duct transports the desired material and the external duct acts as a protective jacket.

In another embodiment of the method according to the invention, the mould comprises two flat elements spaced apart and the foam-forming reaction mixture is introduced between these flat elements. In this way, discontinuous panels can be produced, as required for insulation and fire protection purposes. Preferably, one or both flat elements are made of metal.

In another embodiment of the method according to the invention, the foam-forming reaction mixture is introduced through a mixing head with a mixing chamber and in addition, the outflow cross section of the mixing chamber is varied during the introduction. This can be achieved by means of suitable modifications of a mixing head and integration into a control program.

In this way, the mixing quality of the reaction mixture can be maintained at a uniformly high level with varying melt throughputs. With low melt throughputs, the outflow cross section is kept smaller than with higher melt throughputs.

The optimum throttling that this establishes permits the utilisation of the maximum discharge bandwidth of constant pressure injectors over the shot time with moderate varying of the injection pressure of +/−15% around an average value (150 bar) and a constantly good mixing result. When mixing heads with more than two nozzles per component are used, it is possible in many cases through combinations of nozzles to vary the discharge bandwidth over the discharge performance of the entire mixing head to 1:6 or 6:1.

The present invention is explained further with the aid of the following drawings, but without being limited thereto. The figures show the following:

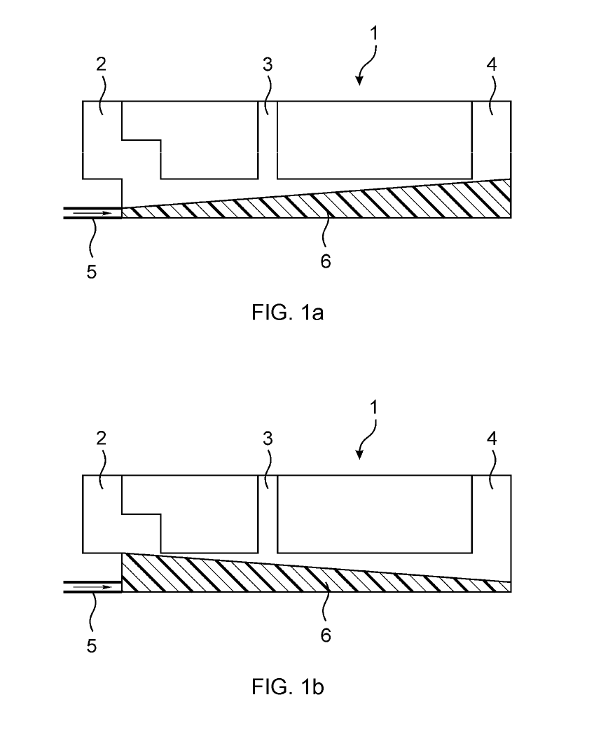

FIG. 1a the filling of a mould with a foam-forming reaction mixture

FIG. 1b a further filling of a mould with a foam-forming reaction mixture

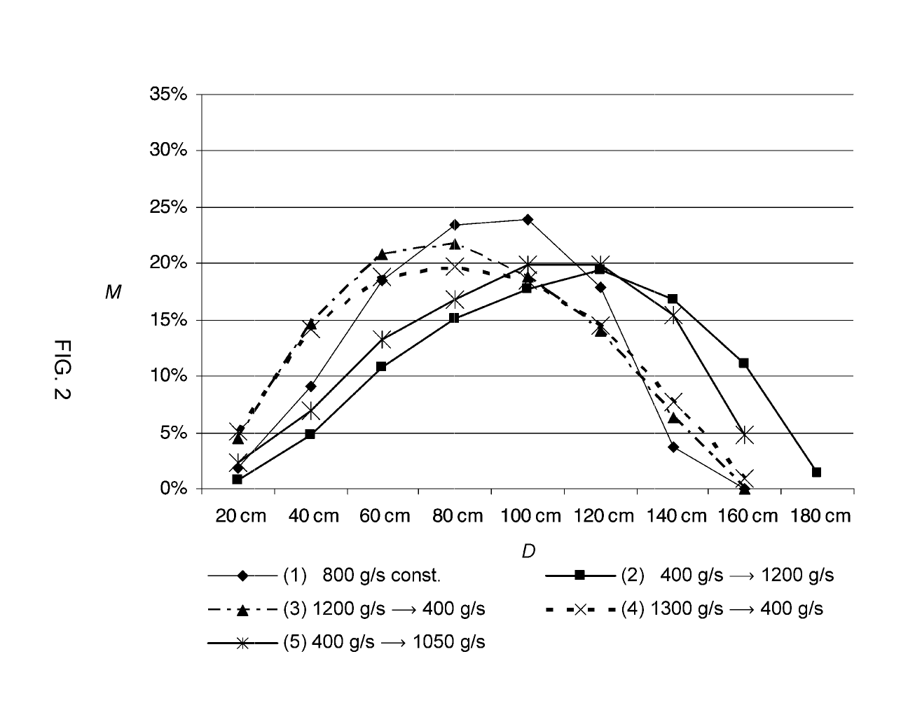

FIG. 2 distance-dependent quantity profiles during discharge of a reaction mixture on to a paper web with varying delivery rate

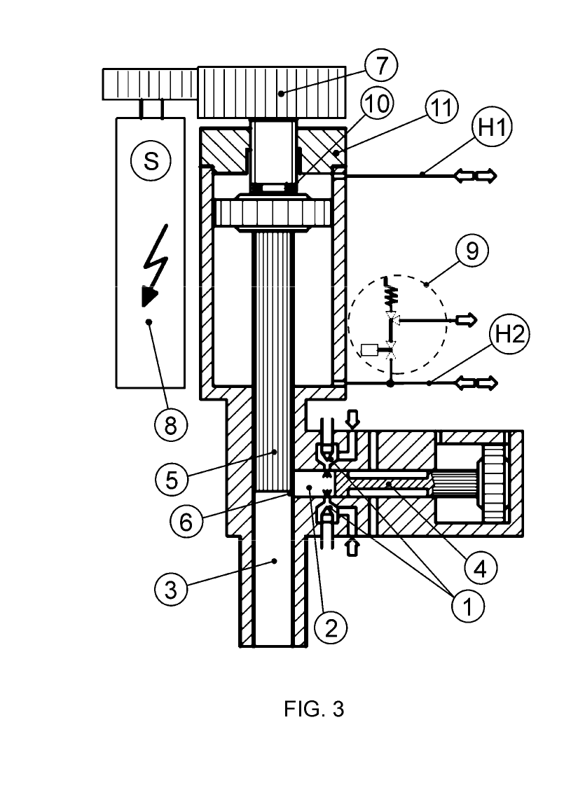

FIG. 3 a modified mixing head in a working position

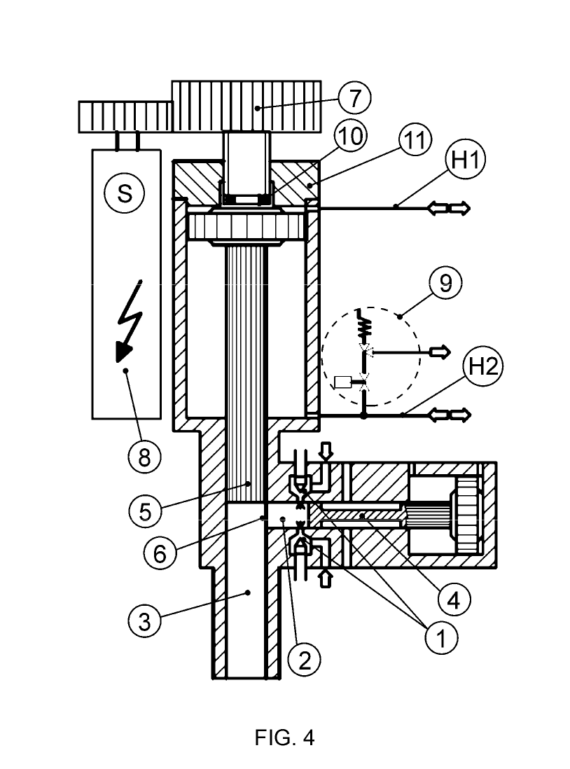

FIG. 4 a modified mixing head in another working position

FIG. 1a shows a diagram of the state shortly after the filling of a mould 1 with a foam-forming reaction mixture 6. The mould 1 is designed as a hollow body and is shown in cross sectional view. The mould 1 can be an insulation element for a combination of refrigerator and freezer. Thus, the horizontal mould 1 has vertically arranged sections 2, 3 and 4. Section 2 forms the base section, section 3 separates refrigerator compartment and freezer compartment from one another and section 4 forms the head section. A horizontally arranged base volume is formed. The cavities of sections 2, 3 and 4 form vertically arranged volumes communicating with the base volume.

For filling the mould, a discharge tube 5 is connected with a corresponding feed opening in the mould 1. From the discharge tube 5 a foam-forming reaction mixture 6, which preferably gives a polyurethane foam, is introduced. In the case illustrated in FIG. 1a, the reaction mixture 6 was first introduced in a large quantity per unit of time and then the quantity was continuously reduced. As a result of the initial high melt throughput and thus the high delivery rate of the reaction mixture from a mixing head which is not illustrated in more detail, the reaction mixture 6 was conveyed into the rear section of the mould 1. A successive reduction of the melt throughput conveyed reaction mixture 6 into the front part of the mould 1. Thus, reaction mixture 6 is applied uniformly over the entire length of the mould 1.

In this way, the wedge-shaped profile of the reaction mixture 6 shown in FIG. 1a is obtained after the foaming has already started in the rear part of the mould 6. The cavity of section 4 of the mould 1 is filled with foam first. With further onset of the foaming reaction, material is pressed into the cavities of sections 3 and 2. In conjunction with an improved predistribution of the initially still liquid reaction mixture over the entire area, more uniform flow path distances are obtained within the mould 1. As a result, a more homogeneous bulk density distribution is obtained together with more isotropic cell geometries with improved mechanical properties and insulation properties within the foamed moulding that is obtained.

FIG. 1b shows the opposite case of the filling of the mould 1 compared with FIG. 1a. Here, the reaction mixture 6 was first introduced in a small quantity per unit of time and then the quantity was increased. In this way, for example, a larger volume located close to the feed opening, as represented by the cavity of section 2, can easily be reached.

FIG. 2 shows results of preliminary tests in which a rigid polyurethane foam system blown with liquid blowing agent was applied with a varying delivery rate on to a paper web which was not laterally restricted. Furthermore, a comparative test (1) is shown, in which the discharge quantity remains constant over time at 800 g/s. On the x-axis the distance from the discharge tube is shown in cm and on the y-axis the quantity, expressed in %, of the total shot quantity of the respective test. The shot period was approx. 8 seconds in each case.

In tests (3) and (4), starting from an initial discharge quantity of 1200 and 1300 g/s respectively, this value was reduced over the course of the tests to 400 g/s. In tests (2) and (5), the opposite situation applies. Starting from a value of 400 g/s, this was increased up to a value of 1200 g/s and 1050 g/s respectively.

It can be seen here that in comparative test (1) a narrower quantity distribution occurs with a higher maximum. Tests (2) and (5), in which the discharge quantity per unit of time was increased, show a maximum shifted towards greater distances from the discharge tube and a broader quantity distribution. In tests (3) and (4), in which the discharge quantity per unit of time was reduced, a maximum shifted towards shorter distances and again a broader quantity distribution can be observed.

FIG. 3 shows a modified mixing head for use in an embodiment of the method according to the invention. In the present case it is designed as a transfer mixing head. After leaving the nozzle 1, the reaction components are mixed by kinetic energy in the cylindrical mixing chamber 2, and then flow round a 90° bend into a discharge tube 3, the cross sectional area of which is significantly increased, thus producing a relaxation of flow of the mixture stream.

After completion of the mixture discharge, the component streams are switched into a recirculation position via grooves in the control piston 4. At the same time, by means of the control piston, mixture residues are discharged from the mixing chamber into the discharge tube. Next, the discharge tube is cleaned by means of another ram 5. The switching operations are managed by means of hydraulics “H1” and “H2” shown diagrammatically with pressures of about 100 to 160 bar in order to be able to achieve rapid but also powerful switching movements.

In addition to the cleaning function, the cleaning ram 5 also acts as a throttle element. The travel of the ram 5 is generally limited at a stop by means of a stroke limiter which is manually adjustable via a fine thread, in such a way that the lower end of the ram in the direction of flow creates an overlap of the transfer between mixing chamber 2 and discharge tube 3. Depending on the degree of overlap, the free outflow cross section 6 varies, which affects the mixing chamber pressure level as well as the mixing quality.

In the work position shown here, the mixture discharge is strongly restricted.

In the present modified mixing head, the manual adjustment is disassembled and replaced with a pair of gear wheels 7. On the mixing head housing, a servo motor “S” 8 is attached which is positively connected with the stroke limiter via the pair of gear wheels and is integrated into the plant control system.

For the purpose of reducing the clamping and frictional resistances on the adjusting thread, the hydraulic operating pressure of the cleaning ram 5 is reduced to <10 bar during the mixture delivery phase via a bypass circuit 9 and the contact surface between travel stop and hydraulic piston is uncoupled against transfers of moment by a thrust ball bearing 10. Thus, depending on the direction of travel, the hydraulic pressure only serves to track the hydraulic piston against the variable stroke limiter or to fix its position against the stop surface.

On completion of discharge of the mixture, the servo motor 8 drives the stroke limiter into the upper end position, the thrust ball bearing 10 being pushed into the upwardly limiting cylindrical plate 11. In this position the bypass valve closes and the cleaning ram 5 can be operated with conventional hydraulic pressure.

By using a servo motor, a highly precise and reproducible throttle setting is achieved, which can be adjusted as a function of the mixture discharge via the mixture discharge time.

FIG. 4 shows a modified mixing head which is analogous to that shown in FIG. 3, but because of the different position of the ram 5 the free outflow cross section 6 is enlarged. As a result, the mixture discharge is unrestricted.

### EXAMPLES

Tests were conducted with insulation elements for refrigerator-freezer combinations. These tests investigated which methods can be used to keep the quantity of foam-forming reaction mixture needed for homogeneous foam-filling of the mould as low as possible. A rigid polyurethane foam system blown with a liquid blowing agent was used and the results were evaluated visually by technically trained personnel. In each case, the same mould was used for foam filling.

### Example 1

### (According to the Invention)

In Example 1, the mould was initially filled with reaction mixture at 1200 g/s in a reducing quantity per unit of time up to a final value of 400 g/s. The reduction of the melt throughput took place in a linear fashion, within the limits of what was possible in practice. A total of 4940 g of reaction mixture was introduced. The mould was completely filled with foam. In particular, even the upper edges were sharply delineated.

### Example 2

### (Comparison)

Here, the mould was likewise filled with 4940 g reaction mixture in a constant quantity of 800 g/s. On completion of the foam-filling operation, it was noted that material was missing at the upper end of the insulating element, which can be attributed to incomplete foam filling.

1. A method for producing foamed mouldings, comprising the following:
A) providing a mould and
B) introducing a foam-forming reaction mixture into the mould, wherein
in B) the foam-forming reaction mixture is introduced into the mould under constant injection pressure and in a quantity which is variable over time,
wherein the introduced quantity of the foam-forming reaction mixture is changed over time by varying the output of a pump motor acting on the reaction mixture.

2. The method according to claim 1, wherein the output of the pump motor is varied by varying the speed of the motor using a frequency inverter.

3. The method according to claim 1, wherein the foam-forming reaction mixture is obtained from the reaction of a first and a second reaction component and the first and second reaction components are each introduced into a mixing chamber by means of constant pressure injectors.

4. The method according to claim 1, wherein the foam-forming reaction mixture is selected so that a rigid polyurethane foam is obtained.

5. The method according to claim 4, wherein the foam-forming reaction mixture comprises a setting time of ≧15 s to ≦50 s.

6. The method according to claim 1, wherein the time period during which the foam-forming reaction mixture is introduced into the mould in a quantity which is variable over time is ≧1 s to ≦20 s.

7. The method according to claim 1, wherein in B) the delivery rate of the foam-forming reaction mixture which is introduced is ≧0.5 m/s to ≦6 m/s.

8. The method according to claim 1, wherein the delivery rate of the foam-forming reaction mixture which is introduced decreases over time in B).

9. The method according to claim 1, wherein the delivery rate of the foam-forming reaction mixture which is introduced increases over time in B).

10. The method according to claim 1, wherein before and/or after B) the foam-forming reaction mixture is introduced into the mould at a delivery rate which is constant over time.

11. The method according to claim 1, wherein the foam-forming reaction mixture is introduced into the mould in a horizontal direction in B).

12. The method according to claim 1, wherein the mould seen in cross section comprises a horizontally arranged base volume and vertically arranged volumes communicating with the base volume.

13. The method according to claim 1, wherein the mould comprises an external duct and an internal duct arranged therein and the foam-forming reaction mixture is introduced between the internal duct and the external duct.

14. The method according to claim 1, wherein the mould comprises two flat elements spaced apart and the foam-forming reaction mixture is introduced between said flat elements.

15. The method according to claim 1, wherein the foam-forming reaction mixture is introduced via a mixing head with a mixing chamber and wherein furthermore an outflow cross section of the mixing chamber is varied during introduction of said mixture.
